(19) United States
(12) Patent Application Publication
(10) Pub. No.: US 2020/0356259 A1
(43) Pub. Date: Nov. 12, 2020

(54) INFORMATION PROCESSING APPARATUS, DISPLAY CONTROL METHOD THEREFOR, AND RECORDING MEDIUM

(71) Applicant: LENOVO (SINGAPORE) PTE. LTD., Singapore (SG)

(72) Inventors: Hidetoshi Mori, YOKOHAMA (JP); Kenneth Scott Seethaler, Morrisville, NC (US); Adam Jerome Cavenaugh, Morrisville, NC (US)

(73) Assignee: LENOVO (SINGAPORE) PTE. LTD., SINGAPORE (SG)

(21) Appl. No.: 16/407,906

(22) Filed: May 9, 2019

(51) Int. Cl. G06F 3/0488; G06F 3/0484; G06F 1/16; G06F 3/0489

(52) U.S. Cl. CPC G06F 3/04886; G06F 3/04897; G06F 1/165; G06F 3/0484

(57) ABSTRACT

A laptop PC includes: an object management section configured to manage the position and size of an object to be displayed on a sub-display; a desktop area resizing section configured to resize a virtual desktop area based on the arrangement and size of the object managed by the object management section; a display area specifying section configured to specify a display area to be displayed in the virtual desktop area on the sub-display; and a sub-display driving section configured to display, on the sub-display, drawing data of the display area specified by the display area specifying section.

### FIELD OF THE INVENTION

The present disclosure relates to an information processing apparatus, a display control method therefor, and a recording medium.

### BACKGROUND OF THE INVENTION

For example, when an information processing apparatus such as a desktop PC or a laptop PC is used to do work, plural application windows (hereinafter, also simply called the “windows”) may be invoked on a display to move ahead with work while viewing plural windows simultaneously. For example, when the information processing apparatus is used to do professional work such as graphic-related work, plural tool windows may be displayed simultaneously in addition to a main window as a main work space for drawing to move ahead with work on the main window.

### SUMMARY OF THE INVENTION

As mentioned above, for example, when work on the main window is done while displaying the main window and plural tool windows simultaneously, the work area of the main window may be occupied by the plural tool windows to make it difficult to secure a wide work space.

It is one object of the present disclosure to provide a comfortable working environment even when there is a need to display plural windows simultaneously.

According to a first aspect of the present disclosure, there is provided an information processing apparatus including a main display, a sub-display, and a display control unit configured to control the display of the main display and the sub-display, wherein the display control unit includes: an object management section configured to manage the position and size of an object to be displayed on the sub-display; a resizing section configured to resize a virtual desktop area based on the arrangement and size of the object managed by the object management section; a display area specifying section configured to specify a display area to be displayed in the virtual desktop area on the sub-display; and a sub-display driving section configured to display, on the sub-display, drawing data of the display area specified by the display area specifying section.

According to a second aspect of the present disclosure, there is provided a display control method for an information processing apparatus including a main display and a sub-display, the display control method including the steps of: managing the position and size of an object to be displayed on the sub-display; virtually resizing a virtual desktop area based on the managed arrangement and size of the object; specifying a display area to be displayed in the virtual desktop area on the sub-display; and displaying, on the sub-display, drawing data of the specified display area.

According to a third aspect of the present disclosure, there is provided a non-transitory recording medium storing thereon a display control program executed by an information processing apparatus including a main display and a sub-display, the display control program comprising the steps of: managing the position and size of an object to be displayed on the sub-display; virtually resizing a virtual desktop area based on the managed arrangement and size of the object; specifying a display area to be displayed in the virtual desktop area on the sub-display; and displaying, on the sub-display, drawing data of the specified display area.

### BRIEF DESCRIPTION OF THE DRAWINGS

FIG. 1 is a schematic external view of a laptop PC according to one embodiment of the present disclosure.

FIG. 2 is a diagram schematically illustrating the hardware configuration of the laptop PC according to the embodiment of the present disclosure.

FIG. 3 is a functional block diagram schematically illustrating some of display control functions of the laptop PC according to the embodiment of the present disclosure.

FIG. 4 is a diagram illustrating a schematic configuration of a sub-display control section illustrated in FIG. 3.

FIG. 5 is a diagram conceptually illustrating a virtual desktop area according to the embodiment of the present disclosure.

FIG. 6 is a table illustrating an example of object management information according to the embodiment of the present disclosure.

### DETAILED DESCRIPTION OF THE INVENTION

In the following disclosure, description will be made on the presented subject matter with reference to the accompanying drawings. In the following embodiment, a laptop PC is exemplified as an information processing apparatus and specific examples of components and the arrangement thereof are described to ease the understanding of the present disclosure, but the embodiment is just an example and is not intended to limit the present disclosure.

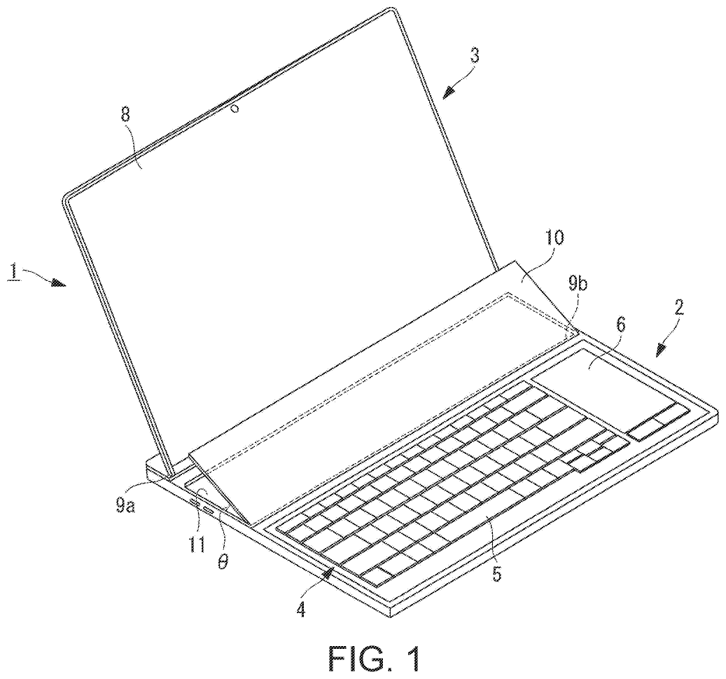

FIG. 1 is a schematic external view of a laptop PC 1 according to one embodiment of the present disclosure. As illustrated in FIG. 1, the laptop PC 1 is a so-called clamshell type personal computer including a first chassis 2 and a second chassis 3 both of which are rectangular parallelepipeds, respectively. The first chassis 2 and the second chassis 3 are coupled by a coupling part 9a, for example, at edges or near the edges of the respective chassis. The coupling part 9a is, for example, a hinge for supporting the first chassis 2 and the second chassis 3 openably and closably.

A sub-display 10 is provided on the first chassis 2 along the edge side of the second chassis 3. The sub-display 10 is coupled to the first chassis 2, for example, by a coupling part 9b. The coupling part 9b is, for example, a hinge. It is so adapted that the sub-display 10 in a closed state can be housed in a housing part 11 provided on the upper face of the first chassis 2, and in an open state, an angle θ between a receiving face of the housing part 11 and a reverse side of the sub-display 10 (a face on which no display screen is provided) will fall within a range of 2° 02<40°, for example.

For example, the sub-display 10 is adapted to be opened with respect to the first chassis 2 when the second chassis 3 is open with respect to the first chassis 2. The sub-display 10 may also be adapted to be rotated manually around the coupling part 9b. In this case, a torque hinge or the like, capable of retaining the sub-display 10 at a predetermined angle, can be suitably used as the coupling part 9b. Further, a biasing member such as a spring may be used to put the sub-display 10 into a state of being biased upward. In this case, when the second chassis 3 is closed, the second chassis 3 can push down the sub-display 10 to be housed in the housing part 11, while when the second chassis is opened, the sub-display 10 can be turned up automatically along with the second chassis 3.

An input device 4 is provided in the first chassis 2. The input device 4 is a user interface to allow a user to perform input operations. In FIG. 1, a keyboard 5 composed of various keys for entering characters, commands, and the like, and a touch pad 6 are illustrated as an example of the input device 4. The input device 4 may also include a mouse, a pointing stick, a touch pen, or the like as a pointing device. Further, the input device 4 may include a microphone for accepting speech input from the user and a speech recognition unit.

The keyboard 5 is provided on the upper face of the first chassis 2 on a side opposite to the second chassis 3 through the sub-display 10. For example, the keyboard 5 is provided substantially in a central region of the upper face of the first chassis 2. The keyboard 5 may be a software keyboard or be composed of physical keys.

The touch pad 6 is provided, for example, on the right side of the keyboard 5 on the upper face of the first chassis 2.

A main display 8 is provided on the second chassis 3 to display images. The main display 8 is arranged on a face opposite to the sub-display 10 in such a state that the second chassis 3 is closed with respect to the first chassis 2. The main display 8 is, for example, to provide a work area for main work, and has a display screen wider than the sub-display 10.

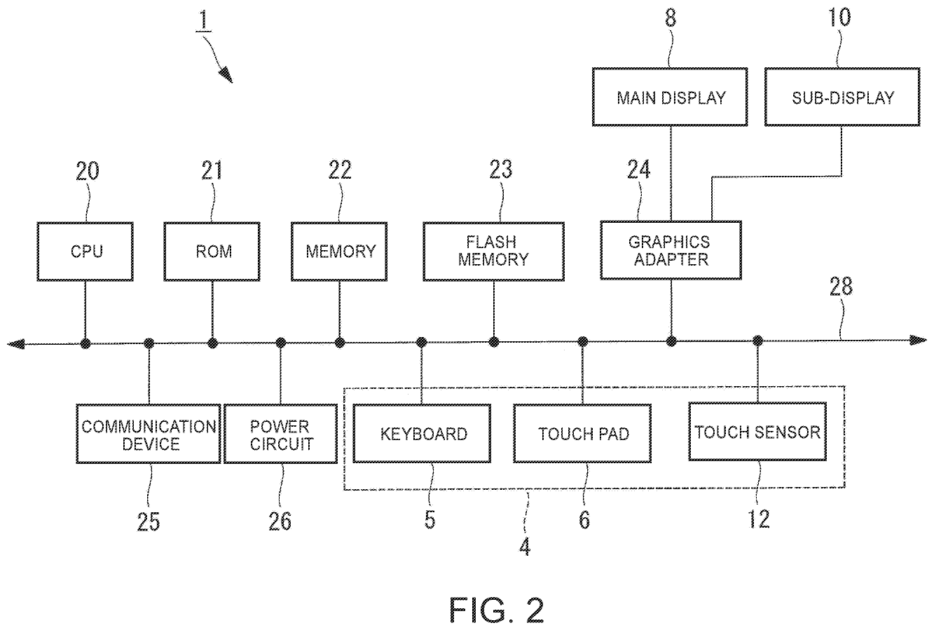

FIG. 2 is a diagram schematically illustrating the hardware configuration of the laptop PC 1 according to the embodiment. The laptop PC 1 includes a CPU (Central Processing Unit) 20, a ROM (Read Only Memory) 21, a memory 22, a flash memory 23, a graphics adapter 24, the main display 8, the sub-display 10, a communication device 25, a power circuit 26, and the input device 4. These components are connected through a bus 28.

The CPU 20 performs entire control of the laptop PC 1 under the control of an OS (Operating System) stored in the flash memory 23 connected through the bus 28 to execute processes based on various programs stored in the flash memory 23.

The ROM 21 stores a BIOS (Basic Input/Output System), various data, and the like.

The memory 22 is composed of a cache memory and a RAM (Random Access Memory). The memory 22 is a writable memory used as a work area for the CPU 20 to read an execution program and write data processed by the execution program.

The flash memory 23 stores a multi-window OS for entire control of the laptop PC 1, various drivers for hardware operations of peripheral devices, utility programs, various application programs, and the like. Note that the laptop PC 1 may include any other storage such as an HDD (Hard Disk Drive) as a storage alternative to the flash memory 23.

The graphics adapter 24 converts display information to a video signal under the control of the CPU 20, and outputs the converted video signal to the main display 8 and the sub-display 10. The graphics adapter 24 includes, for example, a GPU (Graphics Processing Unit) for performing drawing processing, a video memory (VRAM) for holding drawing data, and the like.

The main display 8 is, for example, an LCD (Liquid Crystal Display), an organic EL display, or the like, which is configured to display, as an image, the video signal from the graphics adapter 24 under the control of the CPU 20. Further, in the embodiment, the main display 8 is configured as a touch panel having an input detection function such as a touch sensor, but the present disclosure is not limited thereto.

The sub-display 10 is, for example, an LCD (Liquid Crystal Display), an organic EL display, or the like, to display, as an image, the video signal from the graphics adapter 24 under the control of the CPU 20. The sub-display 10 is a touch panel display provided with a touch sensor 12 superimposed on the display screen. The sub-display 10 may also be adapted to be able to accept input through the touch pen.

The communication device 25 performs communication with other devices.

The power circuit 26 includes an AC adapter, a battery, a charger for charging the battery, a DC/DC converter, and the like, to supply power to each component under the control of the CPU 20.

An input signal according to a user's input operation via the keyboard 5, the touch pad 6, and the touch sensor 12 that constitute the input device 4 is output to the CPU 20 through the bus 28.

The configuration and connection example of the laptop PC 1 illustrated in FIG. 2 are just an example, and the present disclosure is not limited to this example as described above.

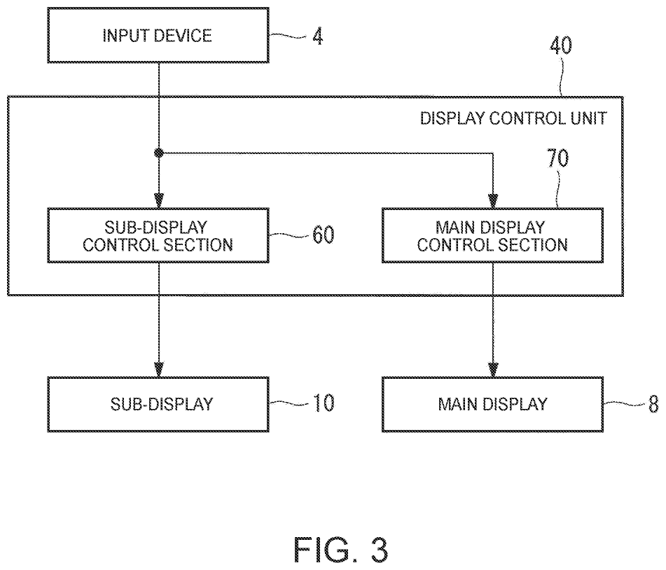

FIG. 3 is a functional block diagram schematically illustrating some of display control functions of the laptop PC 1 according to the embodiment.

Various functions may be implemented by storing, on a computer-readable recording medium, processes for implementing the various functions to be described below, for example, in the format of a program, and reading, into the memory 22, and executing this program by the CPU 20. Further, instead of or in addition to the CPU 20, the various functions may be implemented by a GPU included in the graphics adapter 24.

Note that a form of pre-installing the program on a non-transitory storage medium, such as the ROM or the flash memory 23, a form of providing the program in a state of being stored on a computer-readable, non-transitory storage medium, a form of delivering the program through wired or wireless communication means, or the like may be adopted. The computer-readable, non-transitory storage medium means a magnetic disk, a magneto-optical disk, a CD-ROM, a DVD-ROM, a semiconductor memory, or the like.

As illustrated in FIG. 3, the laptop PC 1 according to the embodiment includes a display control unit 40.

The display control unit 40 has, for example, a function to control a screen display onto each of display screens included in the main display 8 and the sub-display 10 based on various instructions input from the input device 4, such as the keyboard 5, the touch pad 6, and the touch sensor 12 superimposed on each of the main display 8 and the sub-display 10.

The display control unit 40 includes, for example, a sub-display control section 60 configured mainly to perform display control of the sub-display 10, and a main display control section 70 configured mainly to perform display control of the main display 8.

The sub-display control section 60 generates drawing data to be displayed on the sub-display 10, and displays the generated drawing data on the sub-display 10.

The main display control section 70 generates image data to be displayed on the main display 8, and displays the generated image data on the main display 8.

Next, the above-described sub-display control section 60 will be described in more detail with reference to the accompanying drawings.

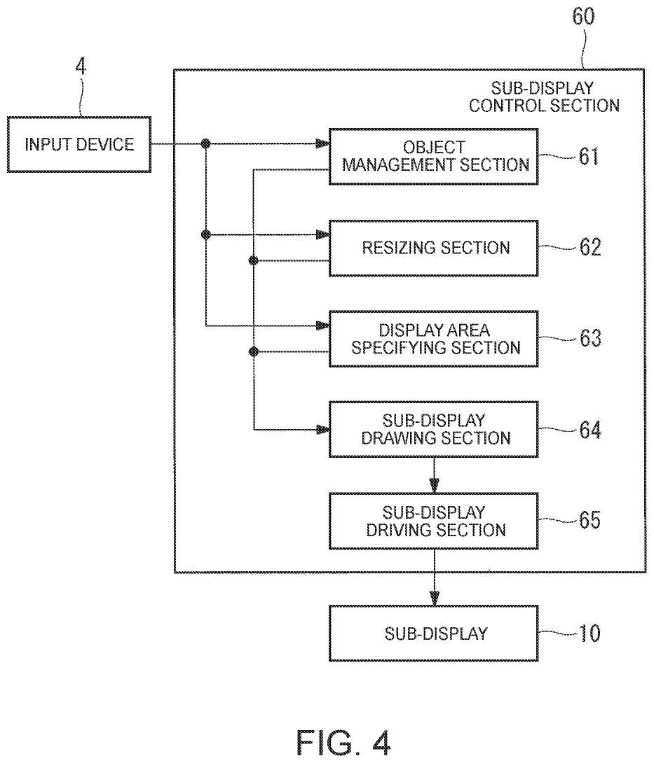

FIG. 4 is a diagram illustrating a schematic configuration of the sub-display control section 60. As illustrated in FIG. 4, the sub-display control section 60 includes, for example, an object management section 61, a resizing section 62, a display area specifying section 63, a sub-display drawing section 64, and a sub-display driving section 65.

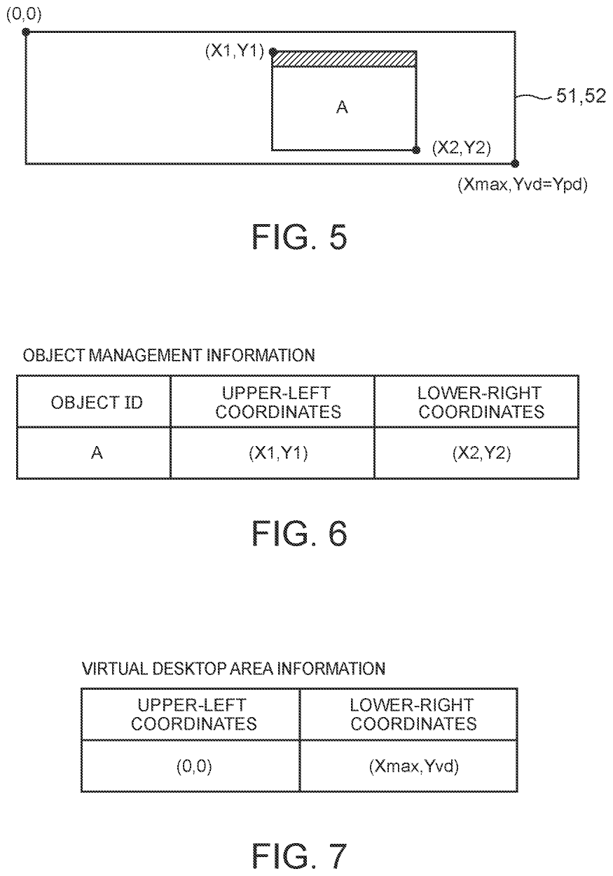

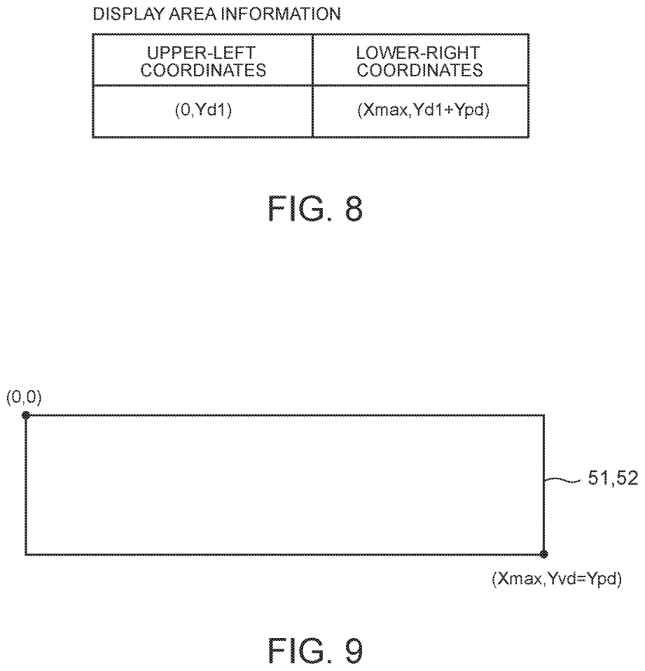

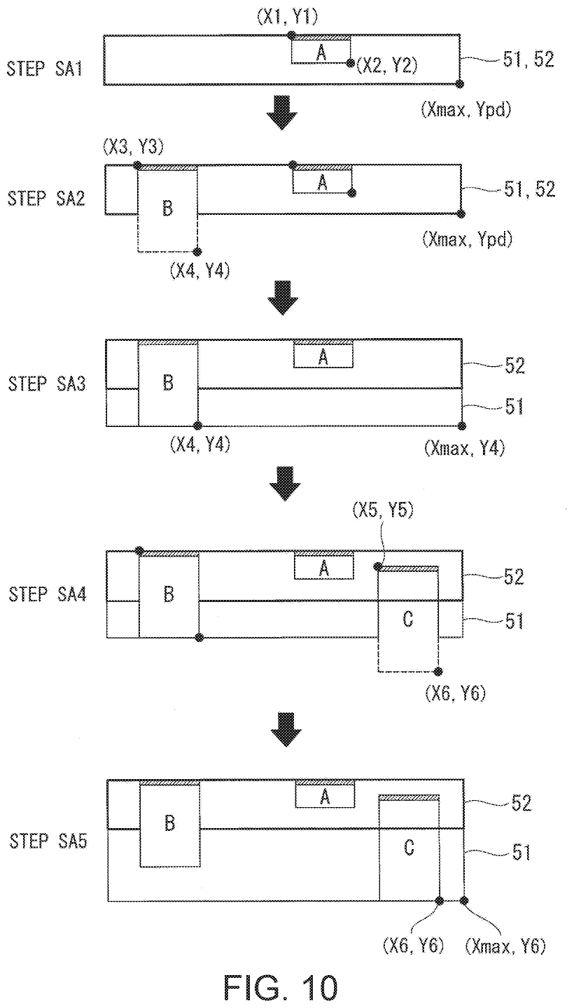

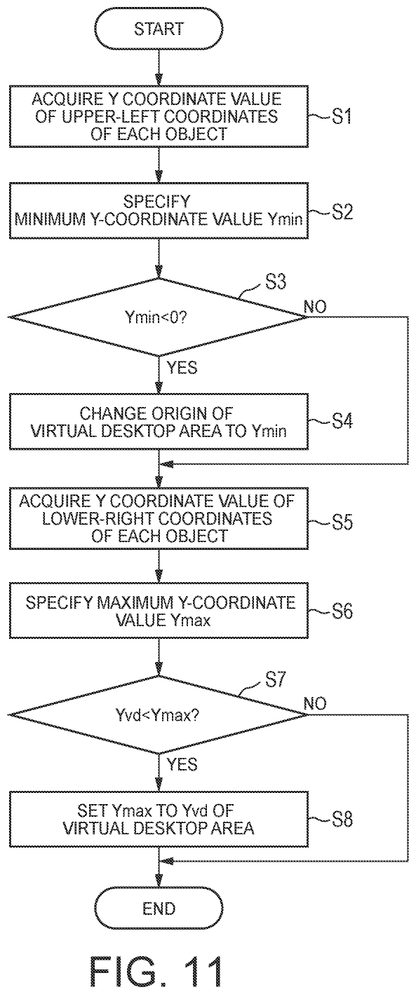

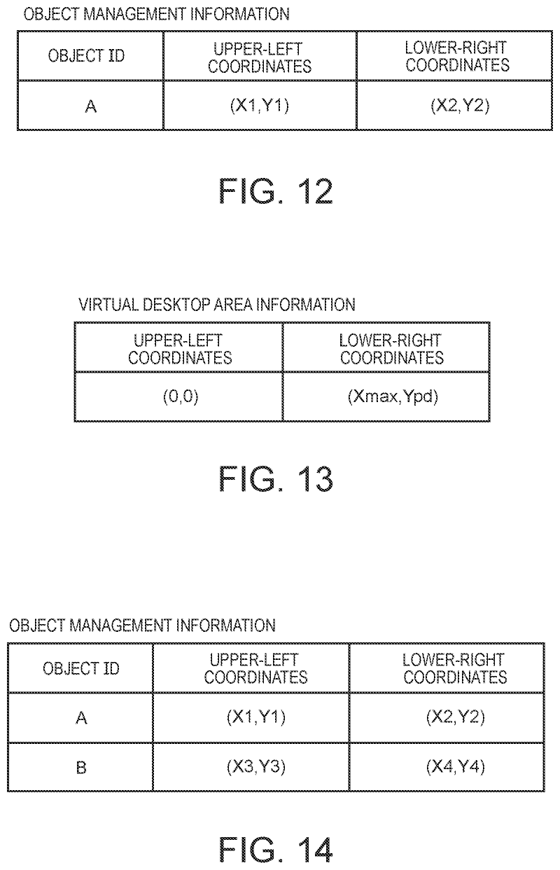

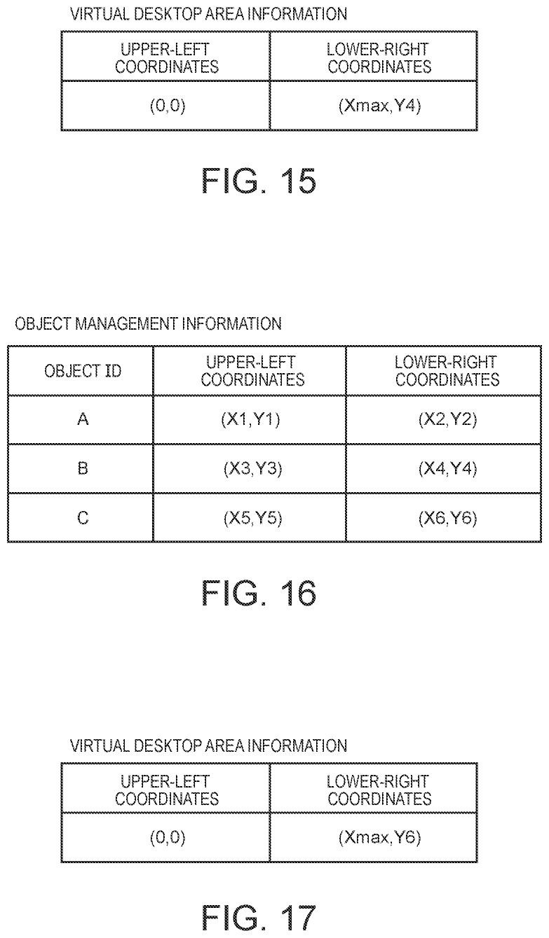

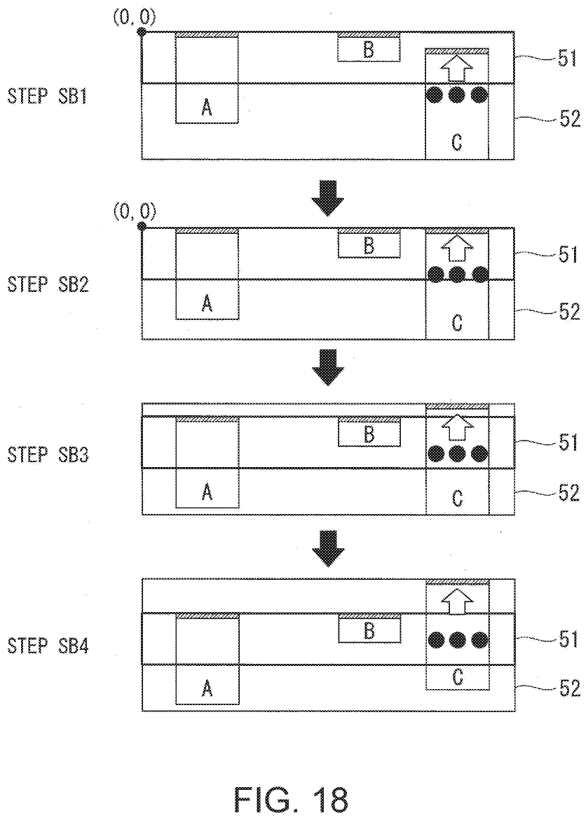

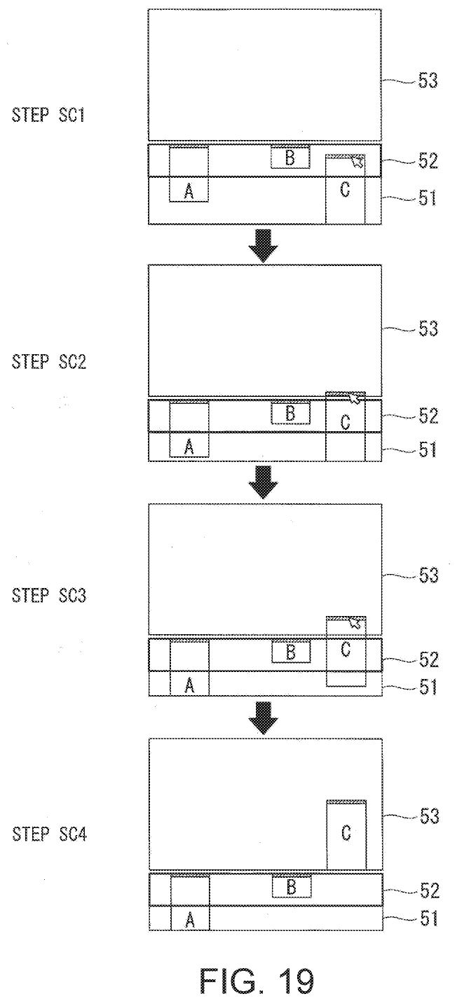

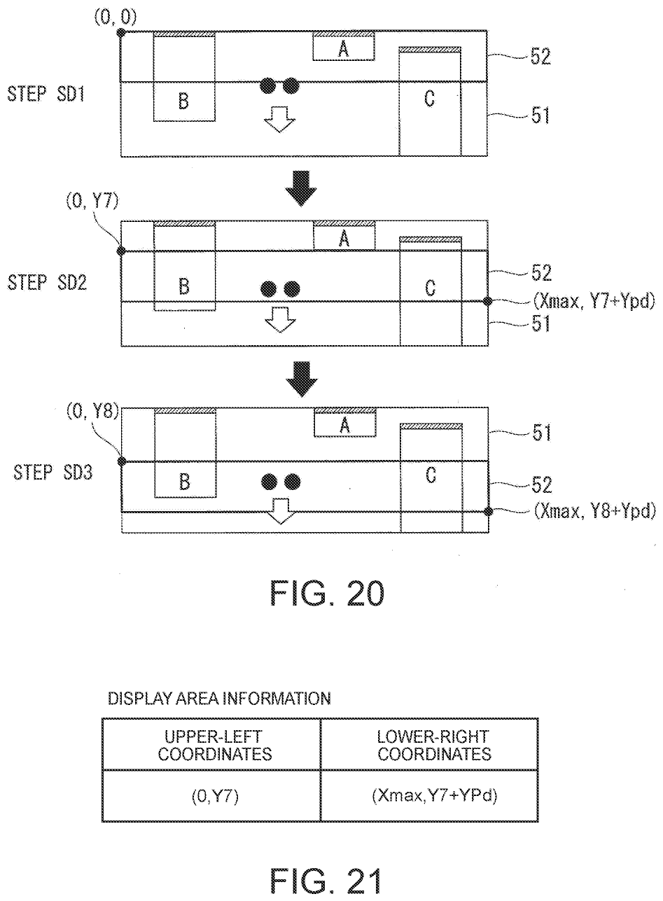

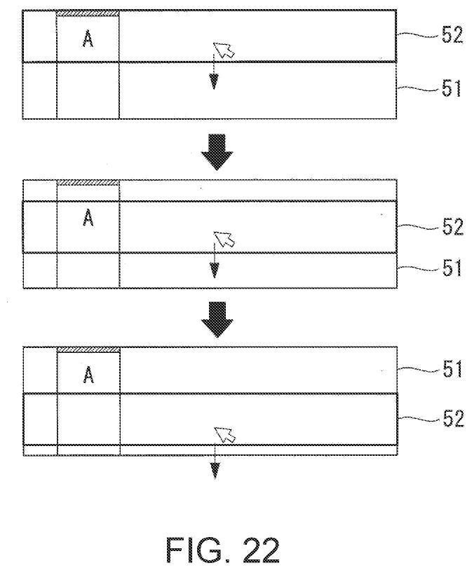

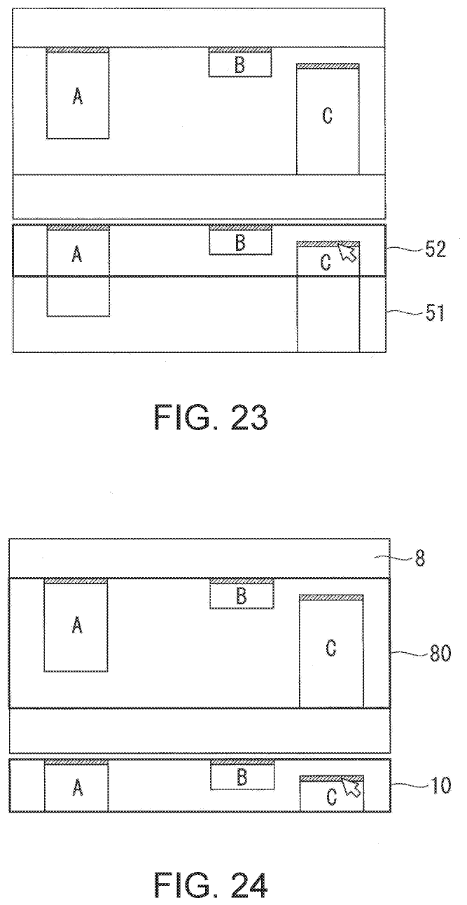

The object management section 61 manages the position and size of an object to be displayed on the sub-display 10. For example, the object management section 61 manages the position and size of each object on the coordinate axes of a virtual desktop area 51 as illustrated in FIG. 5. Specifically, as illustrated in FIG. 6, the object management section 61 has object management information in which identification information on each object is associated with the upper-left coordinates and lower-right coordinates of the object. FIG. 5 and FIG. 6 exemplify a case where an application window A as an example of the object is displayed on the sub-display 10.

The resizing section 62 resizes the virtual desktop area 51 (see FIG. 5) based on the position and size of the object managed by the object management section 61. Here, the virtual desktop area 51 means an area for virtually expanding the desktop of the sub-display 10.

FIG. 5 is a diagram conceptually illustrating the virtual desktop area 51. As illustrated in FIG. 5, the virtual desktop area 51 is rectangular, where the upper left corner is set as the coordinate origin (0, 0), the x-axis is set in the horizontal direction from the upper left corner, and the y-axis is set in the vertical direction from the upper left corner. It is so set that the x-coordinate value increases as it goes right with reference to the upper left corner of the virtual desktop area 51 and the y-coordinate value increases as it goes down from the upper left corner.

As illustrated in FIG. 7, the resizing section 62 has virtual desktop area information in which the upper-left coordinates (0, 0) and the lower-right coordinates (Xmax, Yvd) of the virtual desktop area 51 are set. For example, the resizing section 62 changes the Y-coordinate value Yvd of the lower-right coordinates in the virtual desktop area information to move the lower end of the virtual desktop area 51 in the vertical direction to resize the virtual desktop area 51.

In a default state, the virtual desktop area 51 is set to a size corresponding to a display area 52 of the sub-display 10, and this size in the default state is the minimum size of the virtual desktop area 51.

In the embodiment, the virtual desktop area 51 is made expandable in the vertical direction and fixed in the horizontal direction. One of the reasons for this is that the main display 8 is arranged above the sub-display 10 in the laptop PC 1 according to the embodiment. However, the virtual desktop area 51 is not limited to this example, and it may be made expandable in both the vertical and horizontal directions. Further, for example, when the sub-display 10 and the main display 8 are arranged next to each other in the horizontal direction, the virtual desktop area 51 may be made expandable in the horizontal direction and fixed in the vertical direction.

Although a case where the virtual desktop area 51 is made expandable in the vertical direction is described below for convenience of explanation, it is needless to say that a similar technique can also be used to change the size in the horizontal direction.

The display area specifying section 63 specifies, in the virtual desktop area 51, a display area 52 (see FIG. 5) to be displayed on the sub-display 10. The display area 52 is rectangular, which corresponds to the size of the sub-display 10, and the shape and size of which are fixed.

For example, as illustrated in FIG. 8, the display area specifying section 63 has display area information in which the upper-left coordinates and lower-right coordinates of the display area are set to change the Y-coordinate values of the upper-left coordinates and lower-right coordinates in order to specify the display area 52 in the virtual desktop area 51. Since the shape and size of the display area 52 are fixed, if the Y-coordinate value (e.g. Yd1) of either the upper-left coordinates or the lower-right coordinates is decided, the other Y-coordinate value (e.g. Yd1+Ypd) can be decided by computation.

The sub-display drawing section 64 generates drawing data to be displayed on the sub-display 10 based on the object management information (see FIG. 6) managed by the object management section 61, the virtual desktop area information (see FIG. 7) managed by the resizing section 62, and the display area information (see FIG. 8) specified by the display area specifying section 63. In other words, the sub-display drawing section 64 generates drawing data in an area specified as the display area 52 in the virtual desktop area 51 conceptually illustrated in FIG. 5, and outputs the generated drawing data to the sub-display driving section 65.

The sub-display driving section 65 displays the drawing data on the sub-display 10.

Next, a display control method implemented by the laptop PC 1 according to the embodiment will be described by taking a specific example. In the following description, an application window is taken as an example of an object for convenience of explanation, but the present disclosure is not limited to this example. For example, any object other than the application window, such as an icon, may also be used.

Referring first to FIG. 9 to FIG. 18, processing performed by the object management section 61 and the resizing section 62 included in the sub-display control section 60 according to the embodiment will be mainly described.

For example, as illustrated in FIG. 9, in the default state, where no window is displayed on the sub-display 10, the virtual desktop area 51 is set to a size corresponding to the display area 52 of the sub-display 10.

In this state, for example, when a user uses the input device 4 to enter an instruction to display a new window A on the sub-display 10 with an operation to move the window A displayed on the main display 8 to the sub-display 10, an operation to run a new application, or the like, the object management section 61 writes, into the object management information, information related to the position and size of the window A.

Thus, for example, as illustrated in FIG. 12, the upper-left coordinates (X1, Y1) and the lower-right coordinates (X2, Y2) are written into the object management information in association with the window A. STEP SA1 in FIG. 10 conceptually illustrates a state in which the window A is arranged in the virtual desktop area 51.

The resizing section 62 resizes the virtual desktop area according to the position and size of each object registered in the object management information, for example, at the timing of updating the object management information.

For example, the resizing section 62 specifies upper ends of respective objects managed by the object management section 61, and resizes the virtual desktop area 51 to make the uppermost end among the specified upper ends coincide with the upper end of the virtual desktop area 51. Similarly, the resizing section 62 specifies lower ends of respective objects managed by the object management section 61, and resizes the virtual desktop area 51 to make the lowermost end among the specified lower ends coincide with the lower end of the virtual desktop area 51.

An example of processing performed by the resizing section 62 will be described below with reference to FIG. 11. FIG. 11 is a flowchart illustrating an example of resizing processing performed by the resizing section 62. Note that this processing is not limited to a case where the processing is performed at the timing of updating the object management information as mentioned above. For example, the processing may be performed at a predetermined time interval or predetermined timing.

The resizing section 62 acquires Y-coordinate values of the upper-left coordinates of respective objects from the object management information (S1), specifies the minimum Y-coordinate value Ymin as the smallest Y-coordinate value among the Y-coordinate values (S2), and determines whether the specified minimum Y-coordinate value Ymin is smaller than 0 (S3). As a result, when Ymin<0 (YES in S3), the origin of the virtual desktop area 51 is changed to Ymin as a negative value (S4). In other words, processing for increasing, by a value of Ymin, all Y-coordinate values in the object management information, the Y-coordinate value of the lower-right coordinates of the virtual desktop area information, and all Y-coordinate values in the display area information is performed to move the origin on a conceptual basis.

On the other hand, when it is not Ymin<0 in step S3 (NO in S3), the resizing section 62 acquires Y-coordinate values of the lower-right coordinates of respective objects from the object management information (S5), specifies the maximum Y-coordinate value Ymax as the largest Y-coordinate value among the Y-coordinate values (S6), and determines whether the specified maximum Y-coordinate value Ymax is larger than the Y-coordinate value Yvd of the lower-right coordinates of the virtual desktop area 51 (S7). As a result, when Yvd<Ymax, Ymax is set to Yvd (S8). When the maximum Y-coordinate value Ymax is less than or equal to the lower-right coordinates Yvd of the virtual desktop area 51, the processing is ended without resizing the virtual desktop area 51.

Thus, the above-described processing is performed by the resizing section 62. In this case, for example, in the example of STEP SA1 in FIG. 10, since Y coordinate Y1 in the upper-left coordinates of the window A is 0 (NO in step S3 of FIG. 11), and Y coordinate Y2 in the lower-right coordinates of the window A is smaller than the Y coordinate Ypd in the lower-right coordinates of the virtual desktop area 51 (NO in step S7 of FIG. 11), the virtual desktop area information in the default state as illustrated in FIG. 12 is maintained without resizing the virtual desktop area 51.

Subsequently, for example, when an instruction to display a new window B on the sub-display 10 is input from the input device 4, information on the position and size of the window B is written into the object management information by the object management section 61. Thus, for example, as illustrated in FIG. 14, the upper-left coordinates (X3, Y3) and the lower-right coordinates (X4, Y4) are written into the object management information in association with the window B. STEP SA2 of FIG. 10 is a diagram conceptually illustrating a state where the window B is newly arranged in the virtual desktop area 51.

As described above, the resizing section 62 specifies the minimum Y-coordinate value Ymin=0 of the upper-left coordinates and the maximum Y-coordinate value Ymax=Y4 of the lower-right coordinates among respective objects in the object management information, and compares both values with the Y-coordinate value of the virtual desktop area 51, respectively.

As a result, in the state of STEP SA2 of FIG. 10, since Yvd=Ypd<Ymax=Y4 in terms of the Y-coordinate value of the lower-right coordinates of the virtual desktop area 51, the resizing section 62 updates the Y-coordinate value Yvd of the lower-right coordinates in the virtual desktop area information from Ypd to the maximum Y-coordinate value Y4 as illustrated in FIG. 15. Thus, as illustrated in STEP SA3 of FIG. 10, the size of the virtual desktop area is changed to make the lower end of the window B coincide with the lower end of the virtual desktop area 51. Thus, the virtual desktop area is expanded to such a size as to contain both the window A and the window B.

Then, in the state of STEP SA3 of FIG. 10, when an instruction to display a further new window C on the sub-display 10 is input from the input device 4, the object management section 61 writes, into the object management information, information on the position and size of the window C. Thus, for example, as illustrated in FIG. 16, the upper-left coordinates (X5, Y5) and the lower-right coordinates (X6, Y6) are written into the object management information in association with the window C. STEP SA4 of FIG. 10 is a diagram conceptually illustrating a state where the window C is arranged in the virtual desktop area 51.

The resizing section 62 specifies the minimum Y-coordinate value Ymin=0 of the upper-left coordinates and the maximum Y-coordinate value Ymax=Y6 of the lower-right coordinates among respective objects in the object management information, and compares both values with the Y-coordinate value of the virtual desktop area 51, respectively. As a result, in the state of STEP SA4 of FIG. 10, since Yvd=Y4<Ymax=Y6 in terms of the Y-coordinate value of the lower-right coordinates of the virtual desktop area 51, the resizing section 62 updates the Y-coordinate value Yvd of the lower-right coordinates in the virtual desktop area information from Y4 to Y6 as illustrated in FIG. 17. Thus, as illustrated in STEP SA5 of FIG. 10, the size of the virtual desktop area 51 is updated to make the lower end of the window C coincide with the lower end of the virtual desktop area. Thus, the virtual desktop area is expanded to such a size as to contain all the windows A to C.

Further, in each state of STEP SA1 to STEP SA5 described above, drawing data in an area specified as the display area 52 are generated by the sub-display drawing section 64 and transferred to the sub-display driving section 65 to display, on the sub-display 10, a drawing in the display area 52.

Note that the object management section 61 may have a function to correct the positions of plural objects to make the upper end, lower end, right end, or left end of each object coincide with those of the other objects when plural objects exist in the object management information.

For example, the object management section 61 corrects, to zero, the Y-coordinate value of the upper-left coordinates of each object, and corrects the Y coordinate in the lower-right coordinates according to the correction amount so that the upper ends of all the objects can be aligned with the upper end of the virtual desktop area 51. Thus, the objects can be coordinated to make it easier to view the objects, and displayed on the sub-display 10. Note that the lower end, right end, and left end can also be corrected and aligned in the same way.

Further, for example, when a window (hereinafter called the “window a”) is moved from the main display 8 to the sub-display 10 in order to perform processing from step S1 to step S4 in the flowchart illustrated in FIG. 11, the origin of the virtual desktop area 51 may be changed according to the Y-coordinate value of the upper-right coordinates of the window a at the time when the lower part of the window a is moved to the sub-display 10. Along with this change in the size of the virtual desktop area 51, the upper part of the window a remaining on the main display 8 at the time when the lower part is moved to the sub-display 10 may disappear from the main display 8. To avoid such a state, for example, a window, the whole of which has not been moved completely to the sub-display 10, may be excluded from targets used to resize the virtual desktop area 51, i.e., from objects whose Y-coordinate values are acquired in step S1 of FIG. 11. Thus, for example, such a display form that a window being moved from the main display 8 to the sub-display 10 is moved while being displayed across the main display 8 and the sub-display 10 in a conventional manner can be made.

Next, as illustrated in a conceptual diagram of FIG. 18, when an instruction to move, within the sub-display 10, a window C relative to other windows A and B among windows A to C being displayed on the sub-display 10 is input from the input device 4, the object management section 61 updates the coordinates of the specified window C based on this input instruction.

For example, when an instruction to move the window C upward is input, the object management section 61 continuously decreases the Y-coordinate values of the upper-left coordinates and the lower-right coordinates of the window C in the object management information. Thus, the window C can be virtually moved upward in the virtual desktop area 51.

Further, the resizing section 62 performs the processing illustrated in FIG. 11 at predetermined timing based on the object management information to resize the virtual desktop area 51 according to the movement of the window C. Thus, for example, as illustrated in STEP SB2 of FIG. 18, the origin (0, 0) is updated along with the upward movement of the window C after the Y-coordinate value of the upper-left coordinates of the window C reaches 0 (zero) (steps S1 to S4 in FIG. 11) to perform processing for increasing, according to the amount of movement of the window C, the Y-coordinate values of all objects in the object management information, the Y-coordinate value of the lower-right coordinates of the virtual desktop area information, and all Y-coordinate values in the display area information.

As a result, as illustrated in STEP SB3 and STEP SB4 of FIG. 18, the virtual desktop area 51 is expanded along with the upward movement of the window C to make the upper end of the window C coincide with the upper end of the virtual desktop area 51 to resize the virtual desktop area 51 to contain all the windows A to C and the whole of each of the windows A to C. Then, in each of STEP SB1 to STEP SB4 of FIG. 18, drawing data in the display area 52 are generated by the sub-display drawing section 64, and the drawing data are transferred to the sub-display driving section 65 to provide such a display on the display screen of the sub-display 10 as if only the window C were moved.

Further, resizing the virtual desktop area 51 along with the movement of the window C can avoid displaying the window C on the main display 8.

As an example of an input operation to move any one window relative to the other windows in the vertical direction within the sub-display 10, there is an input operation to touch the sub-display 10 with three fingers and move the three fingers upward or downward in the state, for example, as illustrated in FIG. 18.

Although the case where the position of the window C is moved is illustrated in FIG. 18, the same applies to a case where the window C is resized. In other words, when an instruction to resize the window C is input and the object management information is updated based on the instruction, the resizing section 62 performs the processing illustrated in FIG. 11 based on the updated object management information to resize the virtual desktop area 51 along with the resizing of the window C.

Further, for example, as illustrated in FIG. 19, when the title bar of any of windows being displayed on the sub-display 10 is clicked with a mouse pointer, and then a drag-and-drop operation is done, the specified window is moved according to the operation content in the same way as the window movement in a typical expanded display function.

In this case, the virtual desktop area 51 is not resized by the resizing section 62 even when the object management information is updated by the object management section 61. Thus, for example, as illustrated in STEP SC1 to STEP SC4 of FIG. 19, a display along with the movement of the window C is provided between the sub-display 10 and the main display 8.

Referring next to FIG. 20 to FIG. 22, processing performed by the display area specifying section 63 included in the sub-display control section 60 according to the embodiment will be mainly described.

For example, suppose that three windows A to C are displayed on the sub-display 10. In this case, when an instruction to move the display of the sub-display 10 totally upward or downward is input through the input device 4, the display area specifying section 63 updates the display area information to move the display area 52 in the virtual desktop area 51 downward according to the input instruction.

For example, the Y-coordinate value of the upper-left coordinates in the display area information can be continuously changed from 0 to Y7, and from Y7 to Y8 as illustrated in STEP SD1 to SD3 of FIG. 20 to virtually move the position of the display area 52 in the virtual desktop area 51. FIG. 21 illustrates an example of the display area information when Y7 is set as the Y-coordinate value of the upper-left coordinates of the display area 52.

Then, drawing data in the display area 52 are generated by the sub-display drawing section 64, and the drawing data are transferred to the sub-display driving section 65 to display, on the display screen of the sub-display 10, the drawing data in the display area 52 conceptually illustrated in FIG. 20 so that the display on the sub-display 10 can be moved downward.

As an example of the input operation to move the display of the sub-display 10 totally upward or downward, there is an input operation to touch the sub-display 10 with two fingers and move the two fingers upward or downward in the state, for example, as illustrated in FIG. 20. As another input operation, there is an input operation to place the mouse pointer in a position where no window is placed on the sub-display 10 as illustrated in FIG. 22 and move the mouse pointer downward or upward in the state.

Referring next to FIG. 23 and FIG. 24, entire display processing provided in the sub-display control section 60 and the main display control section 70 according to the embodiment will be mainly described.

For example, when an instruction for an entire display with a press down of any one key or a combination of two or more keys provided in the keyboard 5 is input, the main display control section 70 (see FIG. 3) generates entire drawing data for displaying the entire virtual desktop area based on the object management information managed by the object management section 61 and the virtual desktop area information managed by the resizing section 62.

Thus, for example, entire drawing data as conceptually illustrated in FIG. 23 are generated based on the object management information and the virtual desktop area information, and the entire drawing data are displayed on the main display 8 to provide a display on the main display 8 as illustrated in FIG. 24. As a result, the entire objects arranged in the virtual desktop area are displayed on the main display 8 in a superimposed manner.

In this case, the main display control section 70 may generate, in the above-described entire drawing data, summary entire drawing data in which drawing of objects is simplified, and display the summary entire drawing data on the main display 8.

Further, when the size of the virtual desktop area 51 is larger than a summary display area 80, the size of which is set less than or equal to the size of the main display 8, the main display control section 70 may generate reduced-size entire drawing data, in which the size of the virtual desktop area 51 is reduced up to that of the summary display area 80, and display the reduced-size entire drawing data in the summary display area 80 of the main display 8.

Thus, the user can rearrange and resize the windows A to C easily while checking the main display 8 larger than the sub-display 10. In other words, when an input operation to rearrange and resize the windows A to C displayed on the main display 8 is performed, an instruction based on the input operation is input to the object management section 61. The object management section 61 updates the coordinates in the object management information based on the instruction to change the position and size of each object in the virtual desktop area 51.

Thus, the changes in the arrangement and size of each window made while viewing the main display 8 can be reflected on the display of the sub-display 10.

Further, when predetermined input to exit from the entire display is done, the main display control section 70 hides the display of the entire drawing data on the main display 8. Thus, for example, the windows A to C illustrated in FIG. 23 are hidden, returning to the display of the main display 8 before the entire drawing data are superimposed.

As described above, according to the laptop PC 1 of the embodiment, since the main display 8 and the sub-display 10 are provided, it is possible, for example, to display, on the main display 8, an application window for doing main work, and display other windows such as tool windows on the sub-display 10. This can lead to preventing the work area on the main display 8 from being occupied by the tool windows. Thus, even when there is a need to display plural windows simultaneously, a comfortable working environment can be provided on the main display 8.

Further, according to the laptop PC 1 of the embodiment, the virtual desktop area 51 for virtually expanding the desktop of the sub-display 10 is provided, and the virtual desktop area 51 is resized according to the object management information managed by the object management section 61. Specifically, the virtual desktop area 51 is resized to contain all objects managed by the object management section 61.

Thus, for example, as illustrated in FIG. 18, even when a window is moved beyond the display area of the sub-display 10, even when a window is resized beyond the display area of the sub-display 10, and even when a window going beyond the display area of the sub-display 10 is newly added, the influence of the movement, resizing, or addition of the window can be confined to the sub-display 10, and the influence of the display on the main display 8 due to each of the above cases can be prevented. Thus, a wide work area can be secured on the main display 8.

Further, according to the embodiment, when a predetermined instruction for an entire display is input, entire drawing data of the virtual desktop area 51 are displayed on the main display 8 as illustrated in FIG. 24. Thus, the user can rearrange and resize the windows A to C easily while checking the main display 8 larger than the sub-display 10.

While each form of the present disclosure has been described above, the technical scope of the present disclosure is not limited to the scope of the form mentioned above. Various combinations, changes, or improvements can be added without departing from the spirit of the invention, and forms to which the combinations, changes, or improvements are added shall be included in the technical scope of the present disclosure.

For example, in the above-described embodiment, the case where the virtual desktop area 51 is expanded or reduced in the vertical direction is described. However, for example, when the virtual desktop area 51 is expanded or reduced in the horizontal direction, the resizing section changes the left end and right end of the virtual desktop area 51 based on the object management information. In this case, for example, the resizing section specifies right ends of respective objects managed by the object management section 61, and resizes the virtual desktop area to make the rightmost end among the specified right ends coincide with the right end of the virtual desktop area 51. Similarly, the resizing section specifies left ends of respective objects managed by the object management section 61, and resizes the virtual desktop area to make the leftmost end among the specified left ends coincide with the left end of the virtual desktop area.

1. An information processing apparatus comprising:
a main display;
a sub-display; and
a display control unit configured to control display of the main display and the sub-display,
wherein the display control unit comprises:
an object management section configured to manage a position and size of an object to be displayed on the sub-display;
a resizing section configured to resize a virtual desktop area based on arrangement and size of the object managed by the object management section;
a display area specifying section configured to specify a display area to be displayed in the virtual desktop area on the sub-display; and
a sub-display driving section configured to display, on the sub-display, drawing data of the display area specified by the display area specifying section.

2. The information processing apparatus according to claim 1, wherein when an instruction to move an entire display of the sub-display is input, the display area specifying section is further configured to change a position of the display area in the virtual desktop area based on the instruction.

3. The information processing apparatus according to claim 1, wherein the resizing section is further configured to specify respective upper ends of the objects managed by the object management section, and to resize the virtual desktop area to make an uppermost end among the specified upper ends coincide with an upper end of the virtual desktop area.

4. The information processing apparatus according to claim 1, wherein the resizing section is further configured to specify respective lower ends of the objects managed by the object management section, and to resize the virtual desktop area to make a lowermost end among the specified lower ends coincide with a lower end of the virtual desktop area.

5. The information processing apparatus according to claim 1, wherein the resizing section is further configured to specify respective right ends of the objects managed by the object management section, and to resize the virtual desktop area to make a rightmost end among the specified right ends coincide with a right end of the virtual desktop area.

6. The information processing apparatus according to claim 1, wherein the resizing section is further configured to specify respective left ends of the objects managed by the object management section, and to resize the virtual desktop area to make a leftmost end among the specified left ends coincide with a left end of the virtual desktop area.

7. The information processing apparatus according to claim 1, wherein the object management section is further configured to correct positions of a plurality of the objects to make at least one of upper ends, lower ends, right ends, and left ends of the plurality of the objects coincide with one another.

8. The information processing apparatus according to claim 1, wherein the display control unit further comprises a main display control section configured to display all of the virtual desktop area on the main display when an instruction for an entire display is input, based on entire drawing data for displaying all of the virtual desktop area based on the position and size of the object managed by the object management section.

9. The information processing apparatus according to claim 8, wherein the main display control section is further configured to generate, as the entire drawing data, summary drawing data schematically representing the object.

10. The information processing apparatus according to claim 8, wherein, when the size of the virtual desktop area is larger than a size of a summary display area set less than or equal to a size of the main display, the main display control section is further configured to generate reduced-size drawing data in which the virtual desktop area is reduced up to the summary display area, and to display the reduced-size drawing data on the main display.

11. The information processing apparatus according to claim 8, wherein, when an instruction to change the position or size of the object displayed on the main display is input, the object management section is further configured to update the position or size of the object based on the instruction.

12. The information processing apparatus according to claim 8, wherein, when an instruction to exit from the entire display is input, the main display control section is further configured to hide the display of the drawing data displayed on the main display.

13. The information processing apparatus according to claim 1, further comprising:
a first chassis; and
a second chassis openably and closeably coupled to the first chassis, wherein
the main display is on the second chassis, and
the sub-display is on the first chassis along an edge side of the second chassis.

14. The information processing apparatus according to claim 1, wherein the object is an application window.

15. A display control method for an information processing apparatus including a main display and a sub-display, the display control method comprising the steps of:
managing a position and size of an object to be displayed on the sub-display;
virtually resizing a virtual desktop area based on managed arrangement and size of the object;
specifying a display area to be displayed in the virtual desktop area on the sub-display; and
displaying, on the sub-display, drawing data of the specified display area.

16. A non-transitory recording medium storing thereon a display control program executed by an information processing apparatus including a main display and a sub-display, the display control program comprising the steps of:
managing a position and size of an object to be displayed on the sub-display;
virtually resizing a virtual desktop area based on managed arrangement and size of the object;
specifying a display area to be displayed in the virtual desktop area on the sub-display; and
displaying, on the sub-display, drawing data of the specified display area.
